(19) United States
(12) Patent Application Publication
(10) Pub. No.: US 2024/0408781 A1
(43) Pub. Date: Dec. 12, 2024

(54) Dog Food Slicing Assembly

(71) Applicants: Louis De Santo, JR., Beaumont, CA (US); Jenny De Santo, Beaumont, CA (US)

(72) Inventors: Louis De Santo, JR., Beaumont, CA (US); Jenny De Santo, Beaumont, CA (US)

(21) Appl. No.: 18/207,429

(22) Filed: Jun. 8, 2023

(51) Int. Cl. B26D 1/45; B26B 29/06; B26D 3/18

(52) U.S. Cl. CPC B26D 1/45; B26B 29/063; B26D 3/18

(57) ABSTRACT

A dog food slicing assembly includes a base that has a plurality of first engagements and a plurality of second engagements. A cutting guide is positionable on the base and each of the second engagements releasably engages the cutting guide for retaining the cutting guide on the base. The cutting guide has concave channel to receive a roll of dog food and a plurality of cutting slots distributed along the cutting guide. A cutting blade is sequentially insertable into each of the plurality of the cutting slots in the cutting guide to slice the roll of dog food into a plurality of disks. A lid is positionable on the base each of the plurality of first engagements releasably engages the lid. A storage recess integrated into the lid and a pair of tongs is stored in the storage recess gripping the plurality of disks of dog food.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to slicing devices and more particularly pertains to a new slicing device for slicing a roll of dog food into a plurality of disks. The device includes a base that has a plurality of first engagements and a plurality of second engagements. A cutting guide is positionable on the base and each of the second engagements releasably engages the cutting guide for retaining the cutting guide on the base. The cutting guide has concave channel to receive a roll of dog food and a plurality of cutting slots distributed along the cutting guide. A cutting blade is sequentially insertable into each of the plurality of the cutting slots in the cutting guide to slice the roll of dog food into a plurality of disks. A lid is positionable on the base each of the plurality of first engagements releasably engages the lid. A storage recess integrated into the lid and a pair of tongs is stored in the storage recess gripping the plurality of disks of dog food.

### (2) Description of Related Art Including Information Disclosed Under 37 CFR 1.97 and 1.98

The prior art relates to slicing devices including a variety of slicing devices that each has a rectilinear shape and a plurality of cutting guides for slicing a food item into a plurality of evenly sized slices and in one instance the cutting guide has a tunnel for receiving a tubular food item. In no instance does the prior art disclose a slicing device that has a concave channel for holding a tubular food item and cutting guides integrated into the concave channel.

### BRIEF SUMMARY OF THE INVENTION

An embodiment of the disclosure meets the needs presented above by generally comprising a base that has a plurality of first engagements and a plurality of second engagements. A cutting guide is positionable on the base and each of the second engagements releasably engages the cutting guide for retaining the cutting guide on the base. The cutting guide has concave channel to receive a roll of dog food and a plurality of cutting slots distributed along the cutting guide. A cutting blade is sequentially insertable into each of the plurality of the cutting slots in the cutting guide to slice the roll of dog food into a plurality of disks. A lid is positionable on the base such that the lid covers the cutting guide and each of the plurality of first engagements releasably engages the lid. The lid has a storage recess is integrated into the lid and a pair of tongs is stored in the storage recess which can be employed for gripping the plurality of disks of dog food.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front phantom view of a dog food slicing assembly according to an embodiment of the disclosure.

FIG. 2 is a top phantom view of an embodiment of the disclosure.

FIG. 3 is a cross sectional view taken along line 3-3 of FIG. 2 of an embodiment of the disclosure.

FIG. 4 is an exploded perspective view of an embodiment of the disclosure.

FIG. 5 is a perspective in-use view of an embodiment of the disclosure.

### DETAILED DESCRIPTION OF THE INVENTION

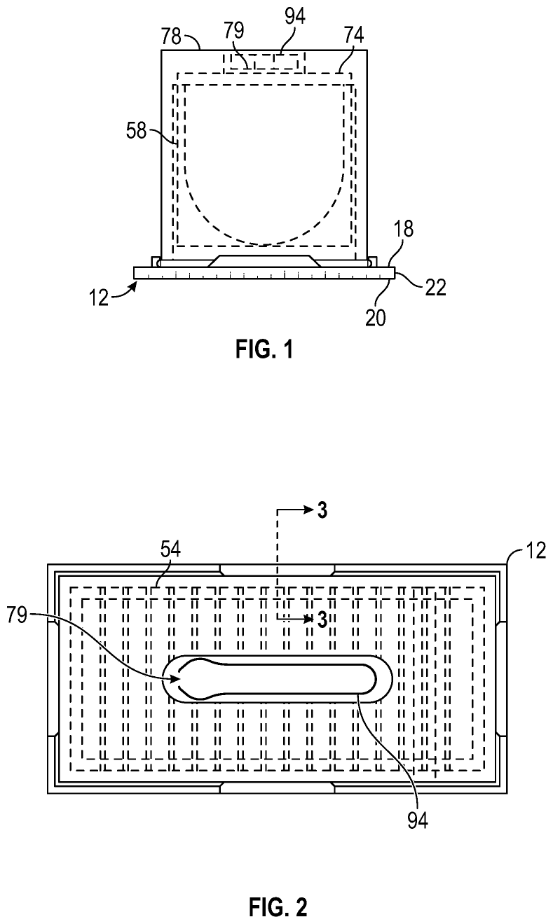

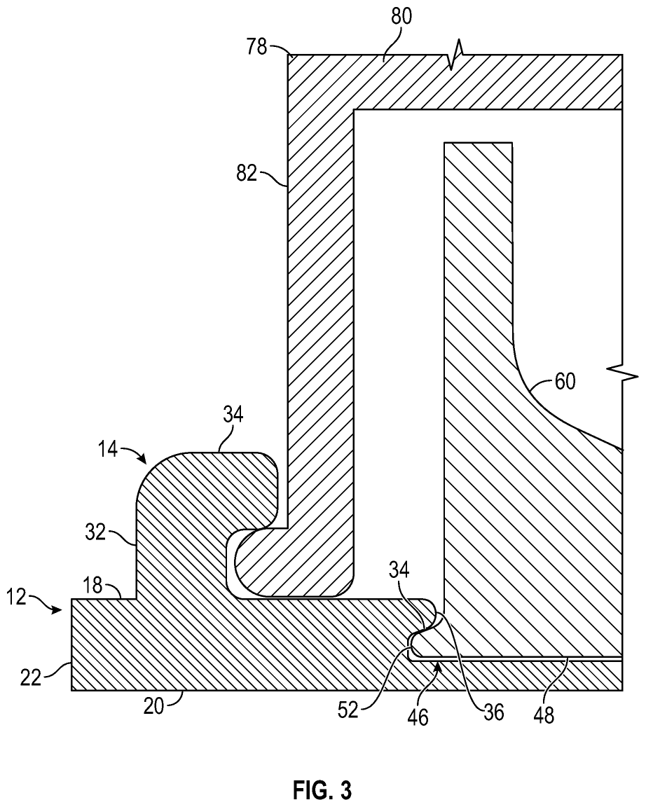

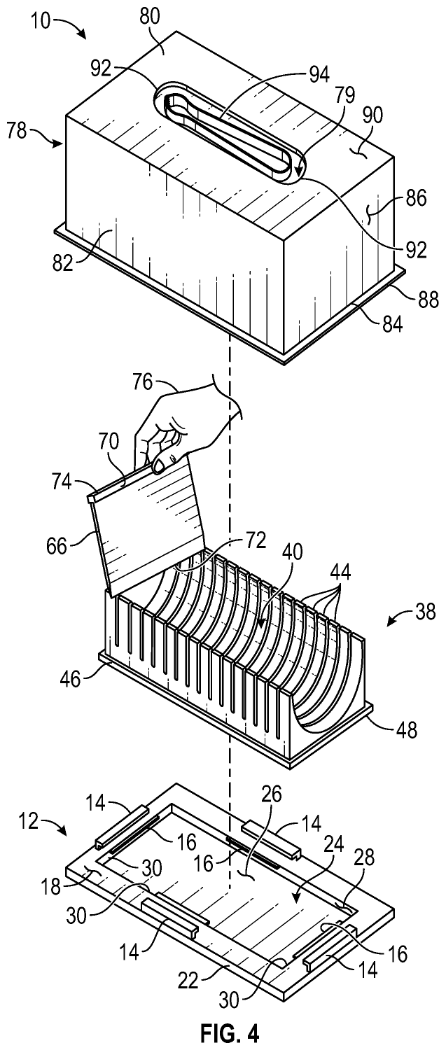

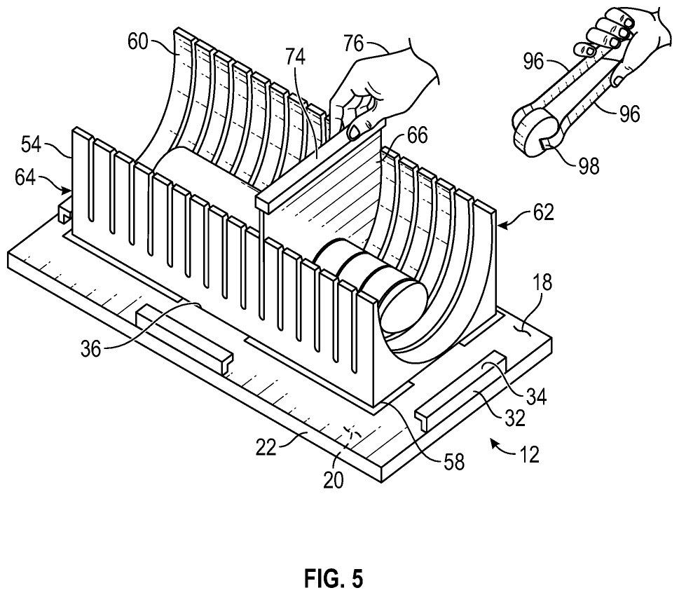

With reference now to the drawings, and in particular to FIGS. 1 through 5 thereof, a new slicing device embodying the principles and concepts of an embodiment of the disclosure and generally designated by the reference numeral 10 will be described.

As best illustrated in FIGS. 1 through 5, the dog food slicing assembly 10 generally comprises a base 12 which has a plurality of first engagements 14 that is each distributed around the base 12. The base 12 has a plurality of second engagements 16 being distributed around the base 12 and the plurality of first engagements 14 surrounds the plurality of second engagements 16. The base 12 has a top surface 18, a bottom surface 20 and a perimeter edge 22 extending between the top surface 18 and the bottom surface 20. The top surface 18 has a recess 24 extending toward the bottom surface 20 and the recess 24 has a lower bounding surface 26 and a lateral bounding surface 28. The lateral bounding surface 28 has a plurality of intersecting sides 30 such that the recess 24 has a rectangular shape; each of the intersecting sides 30 is spaced from and is oriented parallel to a respective one of a plurality of sides of the perimeter edge 22 of the base 12.

Each of the first engagements 14 extends upwardly from the top surface 18 of the base 12 and each of the first engagements 14 is positioned between the perimeter edge 22 of the base 12 and a respective one of the intersecting sides 30 of the lateral bounding surface 28 of the recess 24. Additionally, each of the first engagements 14 is aligned with the perimeter edge 22 of the base 12. Each of the first engagements 14 includes a leg 32 extending upwardly from the top surface 18 and a foot 34 extending toward the recess 24 and the foot 34 associated with each of the first engagements 14 is spaced from the top surface 18 of the base 12. Each of the second engagements 16 comprises a tab 36 extending away from a respective one of the intersecting sides 30 of the lateral bounding surface 28 of the recess 24. Each of the second engagements 16 is aligned with a respective one of the first engagements 14 and each of the second engagements 16 is aligned with the top surface 18 of the base 12.

A cutting guide 38 is positionable on the base 12 and each of the second engagements 16 releasably engages the cutting guide 38 for retaining the cutting guide 38 on the base 12. The cutting guide 38 has concave channel 40 which receives a roll of dog food 42. The roll of dog food 42 may comprise fresh dog food product that is compressed into a tube shaped roll. The cutting guide 38 has a plurality of cutting slots 44 that are distributed along the cutting guide 38.

The cutting guide 38 comprises a panel 46 that has a lower surface 48, an upper surface 50 and an outer edge 52 extending between the lower surface 48 and the upper surface 50. The lower surface 48 rests on the lower bounding surface 26 of the recess 24 having the tab 36 associated with each of the second engagements 16 extending over the upper surface 50 of the panel 46 for retaining the panel 46 in the recess 24. Each of the second engagements 16 is comprised of a resiliently bendable material thereby facilitating each of said second engagements 16 to deform when the cutting guide 38 is positioned in the recess 24. In this way the plurality of second engagements 16 facilitates the cutting guide 38 to be seated in the recess 24. Additionally, the plurality of second engagements 16 returns to their original position when the cutting guide 38 is seated in the recess 24.

The cutting guide 38 includes a half pipe 54 which has a bottom side 58 that is bonded to the upper surface 50 of the panel 46 and the half pipe 54 is spaced inwardly from the outer edge 52 of the panel 46. The half pipe 54 has an upper side 60 that is concavely arcuate with respect to the bottom side 58 such that the upper side 60 accommodates the roll of dog food 42. Each of the plurality of cutting slots 44 extends downwardly into the upper side 60 toward the bottom side 58. The half pipe 54 is elongated between a front end 62 and a back end 64 of the half pipe 54 and the cutting slots 44 are evenly spaced apart from each other and are distributed between the front end 62 and the back end 64 of the half pipe 54.

A cutting blade 66 is provided and the cutting blade 66 can be sequentially insertable into each of the plurality of the cutting slots 44 in the cutting guide 38. In this way the cutting blade 66 can slice the roll of dog food 42 into a plurality of disks 68. The cutting blade 66 has a top end 70 and a bottom end 72 and the bottom end 72 tapers into a sharpened edge to slice the roll of dog food 42. The cutting blade 66 has a grip 74 that is positioned on the top end 70 such that the grip 74 can be gripped by a user 76. The bottom end 72 is slidable downwardly into a respective one of the cutting slots 44 thereby facilitating the cutting blade 66 to be urged downwardly into the plurality of cutting slots 44.

A lid 78 is positionable on the base 12 such that the lid 78 covers the cutting guide 38 and each of the plurality of first engagements 14 releasably engages the lid 78 for retaining the lid 78 on the base 12. Additionally, the lid 78 has a storage recess 79 that is integrated into the lid 78. The lid 78 has a top wall 80 and an outer wall 82 extending downwardly from the top wall 80. The outer wall 82 has a lower edge 84 and an outside surface 86 and the outer wall 82 has a lip 88 extending outwardly from the outside surface 86 of the outer wall 82. The foot 34 associated with each of the plurality of first engagements 14 extends over the lip 88 when the lid 78 is positioned on the base 12 for retaining the lid 78 on the base 12. Each of the first engagements 14 is comprised of a resiliently bendable material thereby facilitating each of the first engagements 14 to be urged away from the lip 88 when the lid 78 is positioned in the recess 24 to facilitate the lip 88 to rest on the top surface 18 of said base 12.

The storage recess 79 extends downwardly into a top surface 90 of the top wall 80 and the storage recess 79 is elongated along the top surface 18. Additionally, the storage recess 79 has a pair of ends 92 that are each rounded such that the storage recess 79 has an ovoid shape. A pair of tongs 94 is included and the pair of tongs 94 are stored in the storage recess 79. In this way the tongs 94 are accessible to the user 76 for gripping the plurality of disks 68 of dog food. The pair of tongs 94 has a pair of members 96 that are biased apart from each other. Each of the pair of members 96 has a distal end 98 which abuts each other when the pair of members 96 are urged toward each other for gripping a respective disk 68 of dog food.

In use, the cutting guide 38 is inserted into the recess 24 in the base 12, the cutting blade 66 is inserted into a respective one of the cutting slots 44 and the lid 78 is positioned on the base 12 for storing the base 12, the cutting blade 66 and the cutting guide 38. The lid 78 is removed from the base 12 and the roll of dog food 42 is positioned in the half pipe 54. The cutting blade 66 is urged downwardly through the roll of dog food 42 and each of the cutting slots 44, one at a time, until the entire length of the roll of dog food 42 is sliced into the plurality of disks 68. In this way the roll of dog food 42 can be precisely sliced into the plurality of disks 68 such that the plurality of disks 68 has a uniform size with respect to each other. Furthermore, the pair of tongs 94 can be employed for gripping a respective disk 68 for placing the respective disk 68 into a feeding bowl for a dog.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dog food slicing assembly for slicing a roll of dog food into a plurality of measured disks, said assembly comprising:
a base having a plurality of first engagements each being distributed around said base, said base having a plurality of second engagements each being distributed around said base, said plurality of first engagements surrounding said plurality of second engagements;
a cutting guide being positionable on said base, each of said second engagements releasably engaging said cutting guide for retaining said cutting guide on said base, said cutting guide having concave channel wherein said concave channel is configured to receive a roll of dog food, said cutting guide having a plurality of cutting slots being distributed along said cutting guide;
a cutting blade being sequentially insertable into each of said plurality of said cutting slots in said cutting guide wherein said cutting blade is configured to slice the roll of dog food into a plurality of disks;
a lid being positionable on said base such that said lid covers said cutting guide, each of said plurality of first engagements releasably engaging said lid for retaining said lid on said base, said lid having a storage recess being integrated into said lid; and
a pair of tongs, said pair of tongs being stored in said storage recess wherein said pair of tongs is configured to be accessible to the user for gripping the plurality of disks of dog food.

2. The assembly according to claim 1, wherein:
said base has a top surface, a bottom surface and a perimeter edge extending between said top surface and said bottom surface, said top surface having a recess extending toward said bottom surface, said recess having a lower bounding surface and a lateral bounding surface, said lateral bounding surface having a plurality of intersecting sides such that said recess has a rectangular shape, each of said intersecting sides being spaced from and being oriented parallel to a respective one of a plurality of sides of said perimeter edge of said base; and
each of said first engagements extends upwardly from said top surface of said base, each of said first engagements being positioned between said perimeter edge and a respective one of said intersecting sides of said lateral bounding surface of said recess, each of said first engagements being aligned with said perimeter edge of said base.

3. The assembly according to claim 2, wherein each of said first engagements includes a leg extending upwardly from said top surface and a foot extending toward said recess, said foot associated with each of said first engagements being spaced from said top surface of said base.

4. The assembly according to claim 2, wherein each of said second engagements comprises a tab extending away from a respective one of said intersecting sides of said lateral bounding surface of said recess, each of said second engagements being aligned with a respective one of said first engagements, each of said second engagements being aligned with said top surface of said base.

5. The assembly according to claim 2, wherein said cutting guide comprises:
a panel having a lower surface, an upper surface and an outer edge extending between said lower surface and said upper surface, said lower surface resting on said lower bounding surface of said recess having said tab associated with each of said second engagements extending over said upper surface of said panel for retaining said panel in said recess; and
a half pipe having a bottom side being bonded to said upper surface of said panel, said half pipe being spaced inwardly from said outer edge of said panel, said half pipe having an upper side being concavely arcuate with respect to said bottom side such that said upper side defines said concave channel, wherein said upper side is configured to accommodate the roll of dog food, each of said plurality of cutting slots extending downwardly into said upper side toward said bottom side, said half pipe being elongated between a front end and a back end of said half pipe, said plurality of cutting slots being evenly spaced apart from each other and being distributed between said front end and said back end of said half pipe.

6. The assembly according to claim 1, wherein said cutting blade has a top end and a bottom end, said bottom end tapering into a sharpened edge wherein said bottom end is configured to slice the roll of dog food, said cutting blade having a grip being positioned on said top end wherein said grip is configured to be gripped by a user, said bottom end being slidable downwardly into a respective one of said cutting slots thereby facilitating said cutting blade to be urged downwardly into said plurality of cutting slots.

7. The assembly according to claim 3, wherein said lid has a top wall and an outer wall extending downwardly from said top wall, said outer wall having a lower edge and an outside surface, said outer wall having a lip extending outwardly from said outside surface of said outer wall, said foot associated with each of said plurality of first engagements extending over said lip when said lid is positioned on said base for retaining said lid on said base.

8. The assembly according to claim 7, wherein said storage recess extends downwardly into a top surface of said top wall, said storage recess being elongated along said top surface, said storage recess having a pair of ends each being rounded such that said storage recess has an ovoid shape.

9. A dog food slicing assembly for slicing a roll of dog food into a plurality of measured disks, said assembly comprising:
a base having a plurality of first engagements each being distributed around said base, said base having a plurality of second engagements each being distributed around said base, said plurality of first engagements surrounding said plurality of second engagements, said base having a top surface, a bottom surface and a perimeter edge extending between said top surface and said bottom surface, said top surface having a recess extending toward said bottom surface, said recess having a lower bounding surface and a lateral bounding surface, said lateral bounding surface having a plurality of intersecting sides such that said recess has a rectangular shape, each of said intersecting sides being spaced from and being oriented parallel to a respective one of a plurality of sides of said perimeter edge of said base, each of said first engagements extending upwardly from said top surface of said base, each of said first engagements being positioned between said perimeter edge and a respective one of said intersecting sides of said lateral bounding surface of said recess, each of said first engagements being aligned with said perimeter edge of said base, each of said first engagements including a leg extending upwardly from said top surface and a foot extending toward said recess, said foot associated with each of said first engagements being spaced from said top surface of said base, each of said second engagements comprising a tab extending away from a respective one of said intersecting sides of said lateral bounding surface of said recess, each of said second engagements being aligned with a respective one of said first engagements, each of said second engagements being aligned with said top surface of said base;
a cutting guide being positionable on said base, each of said second engagements releasably engaging said cutting guide for retaining said cutting guide on said base, said cutting guide having concave channel wherein said concave channel is configured to receive a roll of dog food, said cutting guide having a plurality of cutting slots being distributed along said cutting guide, said cutting guide comprising:
a panel having a lower surface, an upper surface and an outer edge extending between said lower surface and said upper surface, said lower surface resting on said lower bounding surface of said recess having said tab associated with each of said second engagements extending over said upper surface of said panel for retaining said panel in said recess; and
a half pipe having a bottom side being bonded to said upper surface of said panel, said half pipe being spaced inwardly from said outer edge of said panel, said half pipe having an upper side being concavely arcuate with respect to said bottom side such that said upper side defines said concave channel, wherein said upper side is configured to accommodate the roll of dog food, each of said plurality of cutting slots extending downwardly into said upper side toward said bottom side, said half pipe being elongated between a front end and a back end of said half pipe, said plurality of cutting slots being evenly spaced apart from each other and being distributed between said front end and said back end of said half pipe;
a cutting blade being sequentially insertable into each of said plurality of said cutting slots in said cutting guide wherein said cutting blade is configured to slice the roll of dog food into a plurality of disks, said cutting blade having a top end and a bottom end, said bottom end tapering into a sharpened edge wherein said bottom end is configured to slice the roll of dog food, said cutting blade having a grip being positioned on said top end wherein said grip is configured to be gripped by a user, said bottom end being slidable downwardly into a respective one of said cutting slots thereby facilitating said cutting blade to be urged downwardly into said plurality of cutting slots;
a lid being positionable on said base such that said lid covers said cutting guide, each of said plurality of first engagements releasably engaging said lid for retaining said lid on said base, said lid having a storage recess being integrated into said lid, said lid having a top wall and an outer wall extending downwardly from said top wall, said outer wall having a lower edge and an outside surface, said outer wall having a lip extending outwardly from said outside surface of said outer wall, said foot associated with each of said plurality of first engagements extending over said lip when said lid is positioned on said base for retaining said lid on said base, said storage recess extending downwardly into a top surface of said top wall, said storage recess being elongated along said top surface, said storage recess having a pair of ends each being rounded such that said storage recess has an ovoid shape; and
a pair of tongs, said pair of tongs being stored in said storage recess wherein said pair of tongs is configured to be accessible to the user for gripping the plurality of disks of dog food, said pair of tongs having a pair of members being biased apart from each other, each of said pair of members having a distal end which abuts each other when said pair of members are urged toward each other for gripping a respective disk of dog food.
